(19) United States
(12) Patent Application Publication
(10) Pub. No.: US 2025/0371168 A1
(43) Pub. Date: Dec. 4, 2025

(54) CLOUD-AGNOSTIC CODE ANALYSIS

(71) Applicant: Microsoft Technology Licensing, LLC, Redmond, WA (US)

(72) Inventors: James Michael LIMONES, Woodinville, WA (US); Garrett Christopher HALEY, Seattle, WA (US); Steven Alexander MARTINEZ, Woodinville, WA (US); Keith Robert Joseph HITCHCOCK, Seattle, WA (US); Alexis Kristen Phuong Diem VU, Kirkland, WA (US); Trevor DANIELSON, Bellevue, WA (US); Cristian NITULESCU, Duvall, WA (US)

(21) Appl. No.: 19/303,099

(22) Filed: Aug. 18, 2025

Related U.S. Application Data
(63) Continuation of application No. 17/888,205, filed on Aug. 15, 2022.

(51) Int. Cl. G06F 21/57; G06F 21/56

(52) U.S. Cl. CPC G06F 21/577; G06F 21/563

(57) ABSTRACT

To decrease development revision cycle time and reduce deployment and execution errors when porting software from a public cloud to a specialized cloud, the software is analyzed for certain characteristics. Analysis may check for non-permitted items, required items, fragile code, morph code, or deny list expressions, for example. The particular items, codes, expressions, or other characteristics targeted by analysis derive from gapping constraints that distinguish the specialized cloud from public clouds, such as an air-gap constraint, a geolocation constraint, or a government security constraint. Software cloud compatibility analyses may be added, removed, or updated using a modular framework architecture, using declarative analysis module declarations, or both. False positive analysis results may be filtered out. Analysis results may include suggestions. Cloud compatibility analysis helps a public cloud developer make improvements proactively instead of waiting for compatibility feedback from a specialized cloud developer.

### CROSS REFERENCE TO RELATED PATENT APPLICATIONS

This patent application is a continuation of and claims priority to U.S. patent application Ser. No. 17/888,205, filed on Aug. 15, 2022, entitled “CLOUD-AGNOSTIC CODE ANALYSIS;” and hereby incorporated by reference into this patent application.

### BACKGROUND

In computing, a “cloud” is a collection of pooled resources for computing, storage, and networking, which are elastically available for measured on-demand service. A cloud may also be referred to as a “cloud environment” or a “cloud computing environment”, for instance. Although people sometimes refer to “the” cloud, in reality multiple clouds exist. A particular cloud may be a private cloud, a public cloud, a community cloud, or a hybrid cloud, for example. Cloud services may be offered in the form of infrastructure as a service (IaaS), platform as a service (PaaS), software as a service (SaaS), or another service.

Cloud services are often provided or managed using software. Cloud-related software may include hypervisors, applications, deployment tools, other software development tools, security controls, and many other kinds of software. Efforts to improve cloud-related software are widespread and ongoing, but room for improvement remains.

### SUMMARY

Some embodiments described herein address technical challenges related to cloud software development. These challenges include how to simplify and speed up cloud software development while respecting government security constraints. These challenges also include how to reduce build error rates and enhance software reliability when public cloud software is ported to a specialized cloud such as an air-gapped cloud, a geolocation constrained cloud, or a governmental cloud.

Some embodiments assess the compatibility of a piece of software with regard to a specialized cloud by analyzing the software and reporting an analysis result. The analysis result may report the presence of a non-permitted code or a non-permitted code resource which is not permitted in a specialized cloud, or the absence of a required code or a required code resource. The analysis result may report finding a fragile code, which is operable in a public cloud but would be inoperable in the specialized cloud. The analysis result may report detecting a morph code which will operate differently in a public cloud than in the specialized cloud. The analysis may flag a source code for a security review in response to locating in the source code a deny list expression that is associated with the specialized cloud.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce-in a simplified form-some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media;

FIG. 2 is a diagram illustrating aspects of a computing system which has one or more of the cloud software compatibility assessment enhancements taught herein;

FIG. 3 is a block diagram illustrating an enhanced system configured with cloud software compatibility assessment functionality;

FIG. 4 is a block diagram illustrating some aspects of cloud software compatibility assessment; and

FIG. 5 is a flowchart illustrating steps in some methods for cloud software compatibility assessment.

### DETAILED DESCRIPTION

### Overview

Innovations may expand beyond their origins, but understanding an innovation's origins can help one more fully appreciate the innovation. In the present case, some teachings described herein were motivated by technical challenges arising from ongoing efforts by Microsoft innovators to improve the reliability of cloud offerings generally, and to improve software development procedures and outcomes for specialized clouds in particular.

The innovators observed that software development procedures and outcomes for specialized clouds, such as government agency clouds, differ from those of public clouds. Many specialized clouds are subject to security constraints which limit access to software manifests, operational requirements, environment variable settings, customer preferences, and other data that is specific to the specialized clouds. For example, in some cases access is limited to only those developers who have been granted a suitable security clearance by the relevant government. Specialized clouds may also have configuration or operation nuances, issues, or technologies that are not present in a public cloud.

Accordingly, efforts to port cloud software from a public cloud to a specialized cloud regularly encounter errors, inconsistencies, omissions, and other incompatibilities. Resolution of these incompatibilities is significantly complicated and delayed by differences and interaction delays between specialized cloud development and public cloud development.

In a typical scenario, a developer G who is cleared by a government to work on a government cloud obtains previously written software from a developer P who is not similarly cleared and who works instead on the software for use in a public cloud. Developer G's goal is to port the software so it can be used on the specialized government cloud. Ideally, the same version of the software would also be usable on the public cloud, thereby reducing version management burdens and the risk of errors. In practice, an enterprise may include many different specialized cloud teams and many different public cloud teams, which magnifies the complexity discussed here with developer G and developer P.

In the course of porting the software, the government cloud developer G often encounters problems, e.g., the software does not build in the government cloud environment, or it builds but crashes, or it runs without crashing but gives a different and unwanted result than it gives in the public cloud.

Developer G then reports these problems back to developer P. P tries to fix the problems, but even though the problems occurred in the government cloud environment, P works in the public cloud development environment because P does not have access to the government cloud. At some point, P sends G some revised software. Then G tries the software again in the government cloud environment.

Even if the problem has been fixed, several days have likely passed since G discovered the problem and asked P for help. Moreover, there is a significant likelihood that additional problems will be discovered in the revised software, so the entire cycle from G back to P for debugging and then back to G with another revision will be repeated. The cycle time between G and P creates a delay problem that can add weeks or months to a software porting project.

One approach to solving this problem would be to let P work on the software in the government cloud environment instead of limiting P to the public cloud environment. P is usually more familiar with the software than G, and that familiarity is helpful in fixing errors or otherwise changing the software. But this approach would violate the governmental security constraints, so it is not actually a solution to the problem. Moreover, government clouds and other specialized clouds have requirements and nuances that would be unfamiliar to P. G would be familiar with these particularities of the government cloud, but developers like G who have a security clearance to work on a government cloud are scarce, so the most efficient use of their abilities is for them to do work that cannot be done by developers who lack the security clearance.

Accordingly, the innovators sought a way to more cleanly divide specialized cloud development work between public cloud developers and specialized cloud developers. With a clean division of the development work, the public cloud developers will be able to do as much work on the software being ported as they can, while still respecting any government security requirements or other requirements for specialized cloud development. Likewise, with a clean division the specialized cloud developers will be able to give the public cloud developers relevant information about the specialized cloud to assist debugging and other changes, while still respecting government security requirements and all other requirements for specialized cloud development.

However, implementing such a clean division poses some technical challenges. One challenge is deciding whether to allocate any given software development action to the public cloud developers or to the specialized cloud developers. Another challenge is deciding what information about the specialized cloud is both relevant and not restricted from disclosure to the public cloud developers.

To address these and other challenges, the innovators devised cloud-agnostic analysis of software as a way to assess compatibility between public cloud software and a specialized cloud. The analysis is cloud-agnostic in the sense that it promotes software which will work both on public clouds and on specialized clouds, instead of software that is limited to one or the other. As part of a porting process, public cloud software is analyzed for certain incompatibilities with one or more specialized clouds. These incompatibilities are reported, e.g., to the public cloud software developers (potentially many teams), so they can be reduced or removed, thereby improving both the specialized cloud software and the public cloud software. Analysis results may be given a severity level or a confidence level, either by analysis software 302, or by a developer, or both. Analysis results may also, or instead, be reported to a specialized cloud developer. The analysis report may include suggestions or explanations to help guide software changes that will reduce or eliminate the incompatibilities. As illustrated by examples herein, the analysis reports provide public cloud developers with relevant information, without violating security constraints.

Moreover, to help avoid prospective incompatibilities, a piece of public cloud software may be analyzed for incompatibilities that do not presently exist but are expected to emerge as a result of upcoming software changes. In addition, to encourage timely adoption of cloud-agnostic libraries, a piece of public cloud software may be analyzed for incompatibilities even when there is no plan at the time of the analysis calling for that piece of software to be ported to a specialized cloud.

Some embodiments described herein assess the compatibility of a piece of software with regard to a specialized cloud by analyzing the software and reporting an analysis result. The analysis result may report the presence of a non-permitted code or a non-permitted code resource which is not permitted in a specialized cloud, or the absence of a required code or a required code resource. The analysis result may report finding a fragile code, which is operable in a public cloud but would be inoperable in the specialized cloud. The analysis result may report detecting a morph code which will operate differently in a public cloud than in the specialized cloud. The analysis may flag a source code for a security review in response to locating in the source code a deny list expression that is associated with the specialized cloud.

By reporting the presence of a non-permitted code or a non-permitted code resource to a public cloud developer, embodiments beneficially reduce or avoid development cycle time between the public cloud developer and a specialized cloud developer, thereby speeding up and simplifying software development, as well as improving the reliability and security of the software. In particular, software which does not meet a specialized cloud's security requirements can be excluded and be replaced by acceptable software from a list given in the report before the software is turned over to the specialized cloud developer for review or testing.

By reporting the absence of a required code or a required code resource to a public cloud developer, embodiments beneficially reduce or avoid development cycle time between the public cloud developer and a specialized cloud developer, thereby speeding up and simplifying software development, as well as improving the reliability and security of the software. In particular, components that are easily added to a porting package by the public cloud developer can be included before the porting package is given to the specialized cloud developer, instead of having the specialized cloud developer discover their absence and wait while the public cloud developer creates and sends over a more complete package.

By reporting a fragile code or a morph code to a public cloud developer, embodiments beneficially reduce or avoid development cycle time between the public cloud developer and a specialized cloud developer, thereby speeding up and simplifying software development, as well as improving the reliability and security of the software. In particular, the report may suggest alternative code or suggest a code change, which the public cloud developer can make before sending the software to the specialized cloud developer. Without the report, the public cloud developer would not have known a change was called for, because the software ran as expected in the public cloud environment. The public cloud developer would only have learned of the problem from the specialized cloud developer after sending the software to the specialized cloud developer.

By flagging a source code for a security review in response to locating a deny list expression, embodiments beneficially reduce or avoid development cycle time between the public cloud developer and a specialized cloud developer, thereby speeding up and simplifying software development, as well as improving compliance of the software with customer policies and preferences. In particular, the code may be flagged without necessarily telling the public cloud developer what exactly caused the flagging. Indeed, in some embodiments the flagging is not reported to the public cloud developer.

These and other technical benefits will be apparent to a person of skill in the art who ins informed by the teachings provided herein.

### Operating Environments

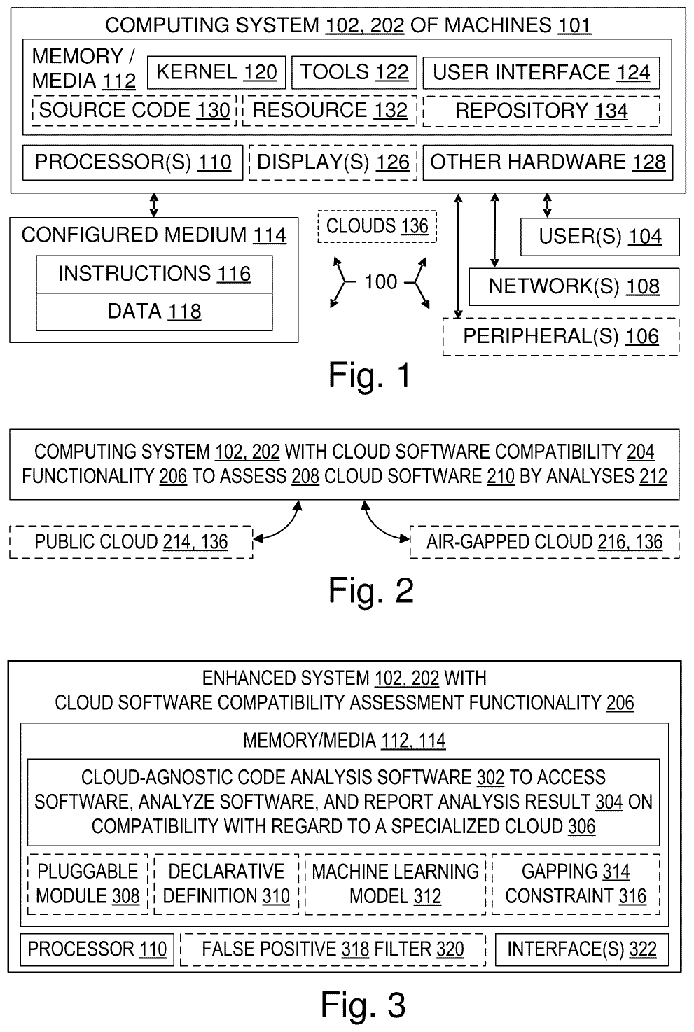

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with a computer system 102 user interface 124 by using displays 126, keyboards 106, and other peripherals 106, via typed text, touch, voice, movement, computer vision, gestures, and/or other forms of I/O. Virtual reality or augmented reality or both functionalities may be provided by a system 102. A screen 126 may be a removable peripheral 106 or may be an integral part of the system 102. The user interface 124 may support interaction between an embodiment and one or more human users. The user interface 124 may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of human user 104. Automated agents, scripts, playback software, devices, and the like running or otherwise serving on behalf of one or more humans may also have accounts, e.g., service accounts. Sometimes an account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. Applications 122 may include software apps on mobile devices 102 or workstations 102 or servers 102, as well as APIs, browsers, or webpages and the corresponding software for protocols such as HTTPS, for example.

Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs, GPUs, and/or quantum processors), memory/storage media 112, peripherals 106, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, cloud software compatibility assessment functionality 206 could be installed on an air gapped network and then be updated periodically or on occasion using removable media 114. A given embodiment may also communicate technical data and/or technical instructions through direct memory access, removable or non-removable volatile or nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

### More About Systems

FIG. 2 illustrates a computing system 102 configured by one or more of the cloud software compatibility assessment enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an enhanced system 202 which is configured with cloud-agnostic code analysis software 302 to provide a functionality 206. Analysis software 302 and other FIG. 3 items are discussed at various points herein, and additional details regarding them are provided in the discussion of a List of Reference Numerals later in this disclosure document.

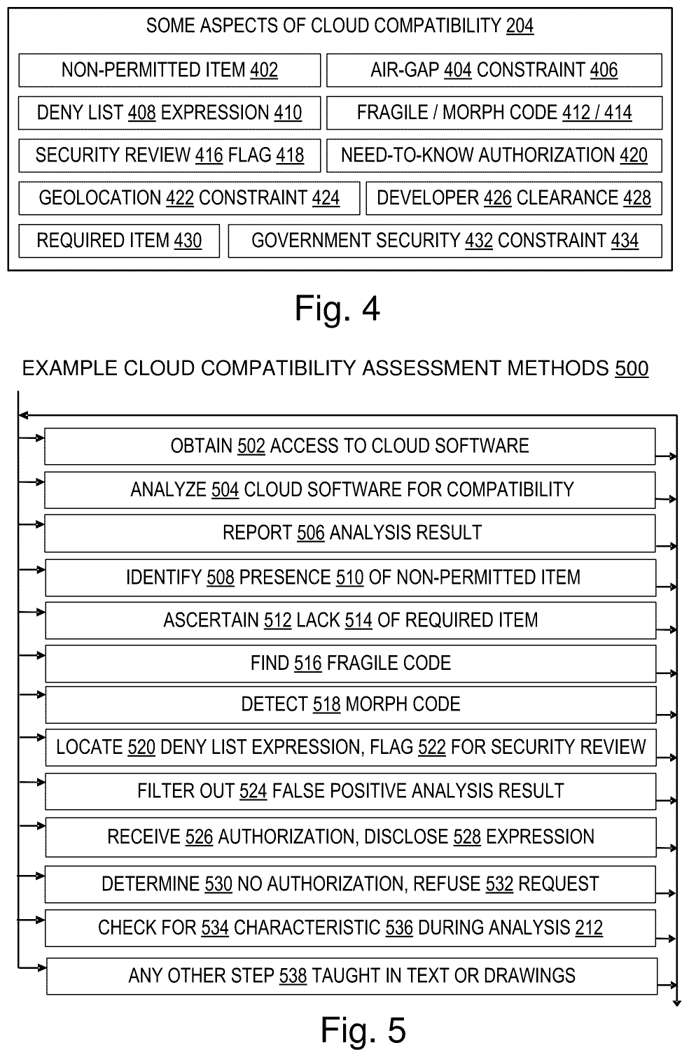

FIG. 4 illustrates some aspects of cloud compatibility 204. FIG. 4 items are discussed at various points herein, and additional details regarding them are provided in the discussion of a List of Reference Numerals later in this disclosure document.

FIGS. 1 through 4 are not themselves a complete summary of all approaches to cloud software 210 compatibility assessment 208. Nor are they a complete summary of all aspects of an environment 100 or system 202 or other computational context of cloud software compatibility assessment 208. FIGS. 1 through 4 are also not themselves a complete summary of all cloud-agnostic code analysis software 302, all aspects of cloud compatibility 204, all cloud software compatibility assessment 208 architecture components, all compatibility assessment 208 scenarios, or all functionalities 206 for potential use in a system 202.

In some embodiments, the enhanced system 202 may be networked through an interface 322. An interface 322 may include hardware such as network interface cards, software such as network stacks, APIs, or sockets, combination items such as network connections, or a combination thereof.

In some embodiments, an enhanced system 202 includes a computing system 202 which is configured to assess software 210 compatibility 204 with specialized clouds 306, such as for example air-gapped 404 clouds 216 or clouds that are subject to a geolocation constraint 424, 316 or a government security constraint 434, 316 or a combination of constraints 316. The enhanced system 202 includes a digital memory 112 and a processor 110 in operable communication with the memory. In a given embodiment, the digital memory 112 may be volatile or nonvolatile or a mix.

In this set of examples, the enhanced system 202 processor 110 is configured by data 118 and instructions 116 to perform a cloud-agnostic code analysis 212 which includes at least one of the following five analyses 212: a non-permitted item analysis 212 which includes checking 534 for or identifying 508 a presence 510 of a non-permitted item 402 which is not permitted in the specialized cloud 306, the non-permitted item including a non-permitted code 210 or a non-permitted code resource 132; a required item analysis 212 which includes checking 534 for or ascertaining 512 a lack 514 of a required item 430 which is required in the specialized cloud 306, the required item including a required code 210 or a required code resource 132; a fragile code analysis 212 which includes checking 534 for or finding a fragile code 412 which is fragile in that the fragile code is configured (not necessarily on purpose) to be operable in a public cloud 214 and be inoperable in the specialized cloud 306; a morph code analysis 212 which includes checking 534 for or detecting 518 a morph code 414 which is configured (not necessarily on purpose) to operate differently in a public cloud 214 than in the specialized cloud 306; or a deny list analysis 212 which includes flagging 522 a source code 130 for a security review 416 after locating 520 a deny list expression 410 in the source code, the deny list expression associated with the specialized cloud 306.

In some embodiments, examples of a non-permitted item 402 include software 210 that is not approved for use in a specialized cloud 306 in any version, or software 210 that is a wrong API version, or software that has not undergone required testing or certification, or software 210 that does not come from an approved source such as an approved vendor or an approved repository 134. Which items are non-permitted items 402 (and which items are required items 430) may be specified by a customer policy, government regulations or statutes, industry guidelines, a contract, or a policy of the cloud service provider, for example. In some embodiments, a fragile code 412 or a morph code 414 is also or instead treated as a non-permitted item 402.

In some embodiments, a presence 510 of non-permitted items 402 may be identified 508, e.g., by scanning a manifest or a build file such as a makefile or a project control file, or by parsing an executable's list of included libraries or dependencies, or by parsing statements in source code, or by using a build chain filter together with a deny list or an allow list during a build, or by a combination of such techniques. As to the lists, items on a deny list may be treated as non-permitted items 402, or items not on an allow list may be treated as non-permitted items 402, or both treatments may apply.

In some embodiments, examples of a required item 430 include software 210 that is approved for use in a specialized cloud 306, or software 210 that is a required API version, or software 210 that has passed required testing or certification, or software 210 that comes from a particular source such as a particular vendor or a particular repository. In some embodiments or circumstances, an override of a default value is a required item. In some embodiments or circumstances, a particular path or path format for obtaining build resources or obtaining data during execution is a required item 430.

In some embodiments, a lack 514 of such required items 430 may be ascertained 512, e.g., by scanning a manifest or a build file such as a makefile or a project control file, or by parsing an executable's list of included libraries or dependencies, or by parsing statements in source code, or by using a build chain filter together with a required items list during a build, or by a combination of such techniques.

In some embodiments, examples of a fragile code 412 include code that includes a hardcoded thumbprint (i.e., a hash, e.g., of a digital certificate), code that includes a hardcoded URL, or code that utilizes a certificate name that is longer than permitted. As to certificate name length, a domain name added to the certificate name in a specialized cloud may be longer than the corresponding domain name that was added to the certificate name in the public cloud, so the result exceeds a permitted certificate name length in the specialized cloud-thereby breaking the software-even though the software operated properly in the public cloud.

In some embodiments, fragile code 412 may be found 516, e.g., by parsing source code, or by submitting code to a machine learning model 312 which has been trained on examples of fragile code 412.

In some embodiments, examples of a morph code 414 include code that includes a network security group, and code that includes default values. A network security group may behave differently in a specialized cloud because security controls and settings may be tighter in the specialized cloud than they were in the public cloud. In particular, if a nonstandard format is used in a public cloud the network security group (virtual firewall) may automatically correct it, whereas rules to handle nonstandard formats may be missing in a specialized cloud.

A default value may lead to different software behavior in a specialized cloud because defaults may be overridden in the public cloud by software that is not running (or is running differently) in the specialized cloud. In particular, a resource manager template default can give a different result in some specialized clouds than it does in the public cloud.

In some embodiments, morph code 414 may be detected 518 using any of the techniques used to find 516 fragile code, any of the techniques used to ascertain 512 the lack of a required item, or any of the techniques used to identify 508 the presence of a non-permitted item.

In some embodiments, examples of a deny list expression 410 include a nation's name, a government agency's name or acronym, a classification level label (e.g., “top secret”), an identification of a cryptographic protocol, a contract number, a combination of terms such as “cloud” plus a customer name, or any term on a list provided by a customer of the specialized cloud service provider. Sources of deny list 408 expressions 410 may include customer policy, government regulations or statutes, industry guidelines, contracts, or a policy of the cloud service provider, for example.

In some embodiments, a deny list expression 410 may be located 520 in a source code 130, or in a resource 132 such as a project file, a makefile, a manifest, or an environment variable, by parsing, or by using a machine learning model 312 which has been trained on examples of deny list expressions 410 and automatically generated variations of them, e.g., misspellings, fragments, digits or wildcards substituted for letters, and so on.

In some embodiments, the system 202 includes multiple independently pluggable cloud-agnostic code analysis modules 308 configured to collectively assess 208 software compatibility 204 with specialized clouds 306. Modules 308 may also be referred to as “scenarios” 308 in recognition of the likely origin of some modules as solutions to particular problem scenarios encountered while porting cloud software 210. This modular architecture facilitates the addition of other cloud compatibility analyses 212 over time, as well as easing implementation revisions of modules 308 that perform the analyses listed above.

In some of these embodiments, each pluggable cloud-agnostic code analysis module 308 includes a declarative module definition 310 specifying a respective cloud-agnostic code analysis 212. Declarative definitions 310 leverage shared functionality to perform analytic variations with a particular focus. For instance, assume that a scenario 308 to find files containing public endpoints already exists. In some embodiments, a declaration 310 can add a scenario 308 that finds code snippets that contain endpoints for all available clouds, without requiring a user to write new procedural code. The user can declare new values for a results filter in a startup config file, along the following lines:

```
{
  “bucket”: “<user's name for filter>”,
  “type”: “Contains”,
  “description”: “<user's description>”,
  “operator”: “AND” // all clouds, inclusive
  “severity”: “<user's designation>”,
  “flaggedValueCategories”: [
    {
      “categoryName”: “<user's name for category>”,
      “keywords”: < list of suffixes for every cloud>
    }
  ],
  “groupingAttribute”: “<attribute that uniquely identifies each finding>”
}
```

The foregoing declaration 310 is merely an example. Other embodiments may use different syntax, different keywords, or different declaration fields, for instance.

In some embodiments, the system 202 includes a machine learning model 312 which is trained to perform at least one cloud-agnostic code analysis 212. For example, a model 312 could be trained to perform non-permitted item analysis 212 using labeled training data that contains problematic URLs such as hardcoded URLs or URLs that reference a location that will be inaccessible due to an air-gap 404. Similarly, a model 312 could be trained to perform deny list analysis 212 using labeled training data that contains deny list expressions and automatically generated variations on them, e.g., misspellings, fragments, digits or wildcards substituted for letters, and so on.

In some embodiments, the specialized cloud 306 is subject to at least one of the following gapping constraints 316: a geolocation constraint 424, an air-gap constraint 406, or a governmental security constraint 434. For example, a cloud 136 might be a specialized cloud 306 because it must be physically located in a facility in the nation Z (a geolocation constraint 424), must never have any connection to the internet (an air-gap constraint 406), and must have no software 210 installed except software that was pre-approved in writing by a director of nation Z's security agency (a governmental security constraint 434). Any one or more of these constraints 424, 406, 434 would also suffice to make the cloud a specialized cloud 306 as opposed to being a public cloud 214, as would other gapping constraints 316. A designated and controlled portion of an otherwise public cloud 214 may also be made into a specialized cloud 306 by the imposition of one or more gapping constraints 316.

These example scenarios are illustrative, not comprehensive. One of skill informed by the teachings herein will recognize that many other scenarios and many other variations are also taught. In particular, different embodiments or configurations may vary as to the number or precise workings of analyses 212, or the number or precise nature of gapping constraints 316 that distinguish a given specialized cloud 306 from public clouds 214, for example, and yet still be within the scope of the teachings presented in this disclosure.

Other system embodiments are also described herein, either directly or derivable as system versions of described processes or configured media, duly informed by the extensive discussion herein of computing hardware.

Although specific memory access management architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. For example, a given embodiment may include additional or different data structure implementations of cloud compatibility analyses 212 and analysis results 304, as well as different technical features, memory aspects, security controls, mechanisms, decision criteria, expressions, hierarchies, operational sequences, environment or system characteristics, or other code improvement functionality teachings noted herein, and may otherwise depart from the particular illustrative examples provided.

Processes (a.k.a. Methods)

Methods (which may also be referred to as “processes” in the legal sense of that word) are illustrated in various ways herein, both in text and in drawing figures. FIG. 5 illustrates a family of methods 500 that may be performed or assisted by an enhanced system, such as system 202 or another cloud compatibility assessment functionality 206 enhanced system as taught herein. FIGS. 1 through 4 show cloud compatibility assessment architectures with implicit or explicit actions, e.g., steps for collecting data, transferring data, storing data, and otherwise processing data.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human 104 may type in text for the system 202 to utilize in a declaration 310. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 5. Arrows in method or data flow figures indicate allowable flows; any arrows pointing in more than one direction thus indicate that flow may proceed in more than one direction. Steps may be performed serially, in a partially overlapping manner, or fully in parallel within a given flow. In particular, the order in which flowchart 500 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments provide or utilize a method 500 to assess software compatibility with specialized clouds 306, the method performed (executed) by a computing system, the method including: obtaining 502 access to a cloud software 210 which includes a source code 130; analyzing 504 the cloud software and reporting 506 a result 304 of the analyzing, the analyzing including at least N of the following five analyses 212: checking for 534 or identifying 508 a non-permitted item 402 which is not permitted in a specialized cloud, the non-permitted item including a non-permitted code or a non-permitted code resource, checking for 534 or ascertaining 512 a lack of a required item 430 which is required in the specialized cloud, the required item including a required code or a required code resource, checking for 534 or finding 516 a fragile code 412 which is fragile in that the fragile code is configured to be operable in a public cloud and be inoperable in the specialized cloud, checking for 534 or detecting 518 a morph code 414 which is configured to operate differently in a public cloud than in the specialized cloud, or checking for 534 or locating 520 in the source code a deny list expression 410 associated with the specialized cloud. In some embodiments Nis one, in some Nis two, in some N is three, in some N is four, and in some N is five. In some embodiments the cloud is a particular kind of specialized cloud 306, e.g., an air-gapped 404 cloud 216, a geolocation constrained 424 cloud, or a government security constrained 434 cloud, or a combination thereof.

In some embodiments, the method includes identifying 508 the non-permitted item. In some embodiments, the method includes ascertaining 512 the lack of the required item. In some embodiments, the method includes finding 516 the fragile code. In some embodiments, the method includes detecting 518 the morph code.

In some embodiments, the method includes locating 520 the deny list expression in the source code and in response flagging 522 the source code for a security review. In some of these embodiments or some circumstances the method also includes receiving 526 a need-to-know authorization 420 and in response disclosing 528 the deny list expression, while in other embodiments or circumstances the method also includes determining 530 that a need-to-know authorization has not been received and in response refusing 532 a request to disclose the deny list expression.

In some embodiments, the method includes filtering 524 out a false positive 318 prior to the reporting 506. For example, a search string may match an item 130 or 132 containing “aes” to a deny list expression 410 “AES” which is an acronym of the Advanced Encryption Standard cryptographic protocol, then that item may be filtered out 524 as a false positive after determining that the match is only partial and the item actually contains “Caesar”.

### Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as a compatibility analysis software 302, analysis modules 308, declarative definitions 310, machine learning models 312, deny lists 408, and filters 320, in the form of data 118 and instructions 116, read from a removable storage medium 114 and/or another source such as a network connection, to form a configured storage medium. The configured storage medium 112 is capable of causing a computer system 102 to perform technical process steps for cloud software 210 compatibility 204 assessment 208, as disclosed herein. The Figures thus help illustrate configured storage media embodiments and process (a.k.a. method) embodiments, as well as system and process embodiments. In particular, any of the process steps illustrated in FIG. 5 or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform a method 500 to assess software compatibility with air-gapped clouds 216. The method 500 includes: obtaining 502 access to a cloud software 210 which includes a source code 130; analyzing 504 the cloud software and reporting 506 a result of the analyzing, the analyzing including at least N of the following seven analyses 212: checking for 534 or identifying 508 a non-permitted code which is not permitted in an air-gapped cloud, checking for 534 or identifying 508 a non-permitted code resource which is not permitted in the air-gapped cloud, checking for 534 or ascertaining 512 a lack of a required code which is required in the air-gapped cloud, checking for 534 or ascertaining 512 a lack of a required code resource which is required in the air-gapped cloud, checking for 534 or finding 516 a fragile code which is fragile in that the fragile code is configured to be operable in a public cloud and be inoperable in the air-gapped cloud, checking for 534 or detecting 518 a morph code which is configured to operate differently in a public cloud than in the air-gapped cloud, or flagging 522 a source code for a security review in response to locating 520 in the source code a deny list expression 410, the deny list expression associated with the air-gapped cloud. Different values for N define different embodiments, and N may be in the range from one to seven.

In some embodiments, the method includes filtering 524 out a false positive analysis result 318, 304 prior to the reporting 506. Other computer-readable storage device 112, 114 embodiments may also vary as to the particular kind of specialized cloud 306, e.g., an air-gapped 404 cloud 216 as in the preceding example, or a geolocation constrained 424 cloud, or a government security constrained 434 cloud, or a combination thereof.

### Additional Observations

Additional support for the discussion of cloud software compatibility assessment functionality 206 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, examples and observations are offered herein.

In some embodiments, some analyses 212 check for problems arising from combinations of different findings and their context, e.g., values that may be innocuous alone get flagged when combined or within particular contexts. Some analyses 212 check for combinations of different conditions that differ in kind from source code values (e.g., project structure, metadata, availability of certain resources, etc.) can be analyzed. Users can plug in values, noteworthy relationships between values, and other independent conditions.

Some analyses 212 check for problems concerning state, environment parity gaps, and relationships between dependencies, e.g., API version tracking. Users can plug in representations of relationships, types of items to target, and how the items should be evaluated based on the specified relationships.

Some analyses 212 check for problems concerning technical constraints to be enforced, e.g., maximum certificate name length, or use of resources or systems that do not exist within a cloud environment 306. Users can plug in constraint parameters, flagged resources and systems, and instructions for evaluating them.

In some embodiments, development teams can identify and publish test scenarios for any of the above items. Teams have the ability to identify new, current, or future requirements, and can customize or extend the test scenarios to meet their needs.

In some embodiments, scenarios 308 may be organized into categories, which are also referred to here as buckets. A given scenario can be in different buckets at different times in the software development process, and can even be in multiple buckets simultaneously. The bucket, scenario relationship may be reported to the user, and may be used for internal development metrics, for example.

Some example aspects of scenarios in a Security bucket include hardcoded thumbprints, and deny list terminology. An example aspect of scenarios in a Compliance bucket is an approved software inventory. Some example aspects of scenarios in an Environmental State bucket include hardcoded network security groups or other virtual firewalls, API versions, certificate name length, and an internally vetted repository manifest check. Some example aspects of scenarios in a Process Improvement or Code Quality bucket include hardcoded URLs, pending requirements (planned or even scheduled but not yet in force), region agnostic code, default values in resource manager templates, resource pathing, scope binding, and parameter formatting.

In some embodiments, a repository is scanned for incompatibilities before repository contents are replicated into a specialized cloud. Problems are reported to the public cloud developers, who can then fix them before replicating the code. This reduces or avoids development cycle time that would otherwise be spent looping with communications back from the specialized cloud engineer 104 to the public engineer 104, recoding, redeploying, and so on. It also reduces cycle time between teams within a company. This also results in better code and more reliable deployments. Because the analyses 212 can be done at build time, notifications 304 will not necessarily delay deployment in the public cloud.

Some embodiments purposefully avoid performing automatic fixes to code being ported. Fix attempts that would be fine in a public cloud may be very risky in a specialized cloud environment. For instance, suppose a call home protocol is hardcoded. This would work fine in a public cloud, but not in an air-gapped cloud. An automatic fix might simply comment out or otherwise disable the call home attempt. This would allow the modified code to run instead of failing at the call home point, but if the call home was being made to verify licensing then preventing the call home creates new problems. A better approach is to report 506 the call home attempt, e.g., as a non-permitted item 402 or as fragile code 412. Then the code can be modified to bring the license in boundary (inside the air-gapped cloud) and change the license verification code accordingly.

Similarly, an automatic fix that simply removes a hardcoded thumbprint would cause execution errors that could be difficult to debug unless the removal was highlighted. A better approach is to replace the hardcoded thumbprint with a thumbprint retrieval that will work properly inside the specialized cloud, e.g., by using an environment variable.

As another example, resource manager default values may cause problems if not overridden in a specialized cloud. A default size for an item may be too large for specialized cloud hardware, but not for public cloud hardware. After the issue is reported, e.g., as fragile code 412, the code can be modified to query and allocate accordingly, instead of trying to allocate the default amount.

As another example, resource paths may work fine—or be easily fixable—in a public cloud environment but not work in an air-gapped cloud. An analysis 212 may check 534 to make sure all paths return the expected resource, and report 506 results accordingly. Otherwise, it may occur that an internal code deployment system finds certain resource files in the public cloud but those files are not shipped to the air-gapped cloud and thus deployment fails in the air-gapped cloud. The resources may be treated as required items 430.

Some embodiments are consistent with a paradigm which views a cloud not as a collection of decoupled services, but instead as a singular unified product where each service is a component of that product. Some embodiments reduce service entropy and move services towards that paradigm by using or providing a software development framework which is traveled by some (or all) services onboarded to a cloud product, to help increase each services' ability to fulfill its role in the overall product. One such framework, referred to here as a Multi-Cloud Unification (MCU) framework, includes an organic, scenario-based analysis tool which identifies major compatibility hurdles a service should overcome to become a successful part of a company's cross-cloud product offering. The MCU tool allows an organization to define an initial set of scenarios comprised of core component requirements, such as cross-cloud secrets management, deployments, coding standards, availability, and testing. The framework has an onboarding system allowing the company to continue to grow and scale core component requirements across all services in the public cloud offering.

The framework may be implemented using virtual machines. For example, analyses 212 may run in a framework on virtual machines that are called by a build pipeline service. The analyses 212 process source code and report 506 back to the build pipeline service with any issues found.

In some embodiments, an MCU tool 302 operates as a scanner, parser, analyzer, and aggregator all in one, moves data through distinct pipeline stages, and produces a comprehensive list of findings. Each pipeline stage itself is designed to be extensible and configurable. Each pipeline stage is also decoupled enough that stages with completely different implementations 308 can be swapped in and out without affecting overall functionality. MCU may come with a suite of widely applicable scenarios, algorithms, and results filters.

In some embodiments, development teams can customize test runs in a large variety of ways by simply modifying a controlling config file 310. As new cloud-readiness lessons are quickly learned, teams can easily add new tests without the hassle of writing new implementation code each time.

In some embodiments, MCU 302 can run on a single repository 134 or on large organizations of repositories. Teams can take advantage of the customizable nature and separate results by their severities using simple declarations 310. This means that the more MCU is used, the more effective it becomes at returning only valuable findings.

In some embodiments, MCU uses C# for implementation due to the language's relatively high performance and wide supportability. However, other programming languages may also be used. Since MCU is scanning, parsing, and processing many individual files and code repositories in a single run, it can become computationally expensive. Despite this, MCU may run quickly and efficiently to integrate into a build process and encourage frequent developer usage. C# has a fast compilation and execution time and supports multiple types of concurrencies.

In some embodiments, MCU 302 MCU also has a wide breadth of features and is written in an accessible language allowing developers to easily extend existing modules to customize their own tests. C# is one such modern language, and supported by the various static analysis tools and development APIs, but C# is not the only language in which the teachings herein can be implemented.

In some circumstances, MCU 302 services are brought onboard by downloading, configuring, and running a local instance of an MCU project, or by using an installation package, or sending requests to an MCU API, or querying an MCU cluster. MCU onboarding may include steps such as: download MCU project repository, configure client authentication, create or get a secret in an MCU registered app, configure environment variables to contain registered app values to authenticate client, create or get global-scoped access token and place in key vault, edit scanning section of config file to match key vault details, specify config file values for test run and scenarios, run MCU C# project, and receive results summary.

In some circumstances, code repository data enters and moves through pipeline stages to produce 506 a list of discovered issues. Scanning gathers the repositories, candidate files, and contents that will be analyzed according to values specified in the startup config file. When running scenarios, for every repo, MCU runs all the specified scenarios on each candidate file. Each file produces results found by the general scenario algorithms, which are then added to the overall MCU results. A results filtering module runs results filters on the overall MCU results and filters out (e.g., designates with a tagged value) findings that meet any of the criteria specified in the startup config file. A logging module may records all the individual MCU results and separate them by issue into buckets. A summary module displays aggregate data describing high-level insights into all the results from a single test run.

In some circumstances, available scan types include an online scan of the remote versions of code repositories via a development API, an offline scan of local versions of code repositories by via a host file system, and an inline scan of a local build time version of a single code repository via integration into a build pipeline.

In some circumstances, results 304 delivery includes multiple CSV (comma separated value) files containing the individual findings and a text file containing the high-level summary of the MCU test run. These artifacts are packaged and located according to the user's specifications in the startup config file. Individual results may have zero or more of the following attributes: individual developer finding information; finding ID, e.g., a SHA256 hash of the {finding link, code snippet, match content, match index}; link to finding 304; incompatibility filename and path; match content; match index; code snippet; file line; reference to abstract syntax tree (AST) node, if applicable; finding category information; scenario 308 or 212 name; scenario group; scenario human-readable description; issue (a.k.a. incompatibility) severity; issue bucket; containing repository information; service tree ID; service name; repository name.

In some circumstances, a results 304 summary has the following details: run ID or timestamp of the test 212 run; length of test run execution; total results found; results by severity: count and percentage breakdown of findings per result category; results by scenario group: count and percentage breakdown of findings per scenario group; results by issue bucket: count and percentage breakdown of findings per issue bucket; list of top repositories that have the highest number of total results; list of top repositories that have the highest number of high severity results.

In some circumstances, results 304 are categorized based on 1) how likely a finding represents a valid issue, and 2) the scope of a finding's impact to a service. This likelihood and scope are determined from a finding's details and the context it exists within. In some cases, regular result types include: high indicating result is likely a valid issue or severely affects service functionality, or both; medium indicating result is potentially a valid issue or moderately affects service functionality, or both; or low indicating result is unlikely to be a valid issue or hardly affects service functionality, or both. Other result types may include exception, a valid finding that the user has designated as allowed. MCU 302 may still log the findings for development quality assurance purposes, but from the user's perspective, exception findings may be ignored.

As to test design, in some circumstances after files are scanned and parsed, tests are run in a two-part phase: 1) running algorithms within a scenario, 2) filtering the results that are output from running the algorithms. The first phase involves running general algorithms 212 and capturing broad instances of findings 304, which then get filtered down and possibly recategorized during the results filtering stage. Tests are designed to be extensible and configurable so teams can customize MCU to fit their specific needs and easily add new tests while minimizing writing new program code. In these examples, test scenarios run at least one available algorithm, and algorithms can be run alone or in tandem.

An example also discussed elsewhere herein is analysis 212 to identify 508 or find 516 hardcoded URLs. Hardcoded endpoints link to resources 132 (e.g., cloud resources, authentication APIs, external websites, etc.) that may not be accessible in every cloud. Usage of hardcoded URLs leads to varying levels of missing functionality and service outages. Hardcoded endpoints are flagged and analyzed for potential issues.

Some hardcoded URL analyses 212 scan repositories according to a scanning query in the config file. Some exclude candidate files in a test suite path to help avoid findings that do not affect service functionality in different clouds. In some, an intermediate scan is based on config value string literals, or using a code search by regular expression (regex). Some match contents using regex for URLs to get hardcoded endpoints. Some get and analyze the associated Abstract Syntax Tree (AST) node for the finding to evaluate its context.

Some hardcoded URL analyses 212 categorize findings based on issue severity. High: hardcoded endpoints with cloud-specific suffixes, and this is a default tag for findings that do not meet any mitigating criteria. Medium: found within a file that has hardcoded endpoints for every available cloud, or within a context that is specific to only a particular cloud, instead of a general context that applies to all clouds. Low: hardcoded endpoint to public documentation, or hardcoded endpoint embedded within help text or similar informational message. Exceptions: hardcoded endpoint to a public schema, false positives, substrings that appear to be URLs (Uniform Resource Locator), but are not true URLs when evaluated within full context.

Another example also discussed elsewhere herein is analysis 212 to identify 508 or find 516 hardcoded thumbprints. Using hardcoded thumbprints is an insecure development practice that lowers a service's security health and its readiness for deployment into multiple clouds. The specific thumbprint being hardcoded will not be available in every cloud environment, and the developer becomes responsible for leaking secrets. Hardcoded thumbprints are flagged and analyzed for potential issues.

Some hardcoded thumbprint analyses 212 scan repositories according to a scanning query in the config file. Some exclude candidate files in a test suite path to help avoid findings that do not affect service functionality in different clouds. In some, an intermediate scan is based on config value string literals, or using a code search by regular expression (regex). Some match contents using regex for partial alphanumeric strings of length 40 (or other applicable thumbprint size) to get hardcoded thumbprints. Some get and analyze the associated Abstract Syntax Tree (AST) node for the finding to evaluate its context.

Some hardcoded thumbprint analyses 212 categorize findings based on issue severity. High: thumbprint variables that immediately get assigned a thumbprint value, thumbprint variables that initially hold a dummy value, and then later get assigned a thumbprint value, and this is also a default tag for findings that do not meet any mitigating criteria. Exceptions: false positives, e.g., other hardcoded objects that are not actually thumbprints, substrings that appear to be thumbprints, but are not true thumbprints when evaluated within full context.

### Technical Character

The technical character of embodiments described herein will be apparent to one of ordinary skill in the art, and will also be apparent in several ways to a wide range of attentive readers. Some embodiments address technical activities such as parsing source code 130, training or executing machine learning models 312, porting software 210 from a public cloud 214 to an air-gapped cloud 216 or other specialized cloud environment 306, filtering 524 compatibility analysis 212 results 304, or scanning 520 code 130 for deny list expressions 410, which are each an activity deeply rooted in computing technology. Some of the technical mechanisms discussed include, e.g., code analysis software 302, machine learning models 312, pluggable modules 308, and filters 320. Some of the technical effects discussed include, e.g., reduction or avoidance of development cycle times when porting software from a public cloud 214 to a specialized cloud 306, more reliable deployments of cloud software 210, flagging 522 of software for a security review 416, and faster and more uniform transitions to software 210 that will comply with forthcoming requirements. Thus, purely mental processes and activities limited to pen-and-paper are clearly excluded. Other advantages based on the technical characteristics of the teachings will also be apparent to one of skill from the description provided.

Different embodiments may provide different technical benefits or other advantages in different circumstances, but one of skill informed by the teachings herein will acknowledge that particular technical advantages will likely follow from particular innovation features or feature combinations.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose beneficial technical effects fully or partially solve particular technical problems, such as how to simplify and speed up cloud software development while respecting government security constraints, and how to reduce errors when public cloud software 210 is ported to a specialized cloud 306. These and other challenges are met, e.g., by running software 210 analyses 212 before replication to the specialized cloud 306. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, peripherals, software process flows, identifiers, data structures, data selections, naming conventions, notations, control flows, or other embodiment implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
ID: identification or identity
LAN: local area network
MAC address: media access control address
OS: operating system
PaaS or PAAS: platform-as-a-service
RAM: random access memory
ROM: read only memory
TPU: tensor processing unit
UEFI: Unified Extensible Firmware Interface
UI: user interface
URL: uniform resource locator
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction right after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin (x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“IoT” or “Internet of Things” means any networked collection of addressable embedded computing or data generation or actuator nodes. An individual node is referred to as an internet of things device or IoT device. Such nodes may be examples of computer systems as defined herein, and may include or be referred to as a “smart” device, “endpoint”, “chip”, “label”, or “tag”, for example, and IoT may be referred to as a “cyber-physical system”. IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage-RAM chips or ROM chips provide the only local memory; (e) no CD or DVD drive; (f) embedment in a household appliance or household fixture; (g) embedment in an implanted or wearable medical device; (h) embedment in a vehicle; (i) embedment in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Cloud compatibility assessment 208 operations such as analyzing 504 software with any of the specific analyses 212 discussed as examples or other assessments 208, executing machine learning models 312, reporting 506 analysis results 304, and many other operations discussed herein, are understood to be inherently digital. A human mind cannot interface directly with a CPU or other processor 110, or with RAM or other digital storage 112, to read and write the necessary data to perform the software cloud 306 compatibility 204 assessment 208 steps 500 taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112 (f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac gadget” and that claim limitation became subject to means-plus-function interpretation, then at a minimum all structures identified anywhere in the specification in any figure block, paragraph, or example mentioning “zac gadget”, or tied together by any reference numeral assigned to a zac gadget, or disclosed as having a functional relationship with the structure or operation of a zac gadget, would be deemed part of the structures identified in the application for zac gadget and would help define the set of equivalents for zac gadget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as analyzing, ascertaining, checking, detecting, determining, disclosing, filtering, finding, flagging, identifying, locating, obtaining, receiving, reporting, (and analyzes, analyzed, ascertains, ascertained, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202, such as a developer or programmer; refers to a human or a human's online identity unless otherwise stated 106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102
120 kernel(s), e.g., operating system(s), BIOS, UEFI, device drivers
122 applications or other software tools, e.g., version control systems, cybersecurity tools, software development tools, office productivity tools, social media tools, diagnostics, browsers, games, email and other communication tools, commands, and so on
124 user interface; hardware and software
126 display screens, also referred to as “displays”
128 computing hardware not otherwise associated with a reference number 106, 108, 110, 112, 114
130 source code; digital
132 software resource, e.g., files, permissions, environment variables, endpoints, APIs, or other items used by software 310 during installation, configuration, or execution; digital, may include hardware
134 software repository; may provide version control; digital and computational
136 cloud generally, also known as cloud computing environment; unless stated otherwise, any discussion of reading from a file or writing to a file includes reading/writing a local file or reading/writing over a network, which may be a cloud network or other network, or doing both (local and networked read/write)
202 system 102 enhanced with cloud software compatibility assessment functionality 206
204 cloud software compatibility as represented or implemented or evident in a cloud, e.g., software S is compatible with cloud C to the extent that S deploys and executes in C without errors or omissions or degraded performance; a public cloud version SP of S may be used as a compatibility baseline, or a functional specification of S may be used as a compatibility baseline
206 cloud software compatibility assessment functionality, also referred to as compatibility assessment functionality; e.g., software or specialized hardware which performs at least one analysis 212 on cloud software 310 with respect to at least one specialized cloud 306, or software or specialized hardware which configured to perform at least steps 504 and 506, or any software or hardware which performs or is configured to perform a method 500 or a computational cloud software compatibility assessment activity first disclosed herein
208 cloud software compatibility assessment, i.e., computational activity which analyzes software for compatibility with respect to at least one specialized cloud 306
210 cloud software, i.e., software which runs in a cloud or is designed to run in a cloud; unless indicated otherwise, software 210 is being ported to a specialized cloud 306, or is scheduled to be ported, or is being deployed to a specialized cloud 306 or is being executed within a specialized cloud 306
212 cloud software compatibility analysis, e.g., computational activity which analyzes software for compatibility with respect to at least one specialized cloud 306 and with regard to at least one of the particular characteristics discussed herein such as non-permitted items 402, required items 430, fragile code 412, morph code 414, or deny list expressions 410; reference numeral 504 refers to the computational performance of one or more analyses 212 or another compatibility 204 analysis
214 public cloud; an example of a cloud 136 which is not subject to any of the gapping constraints 406, 424, or 434
216 air-gapped cloud; an example of a cloud 136 which is subject to an air-gapping constraint 406
302 cloud-agnostic code analysis software, e.g., software which upon execution performs at least steps 502-506
304 digital result of one or more analyses 212
306 specialized cloud, e.g., a cloud that is subject to at least one of the gapping constraints 406, 424, or 434
308 pluggable module which upon execution guides or performs an analysis 212; computational
310 declarative module definition, also referred to as declaration 310; digital artifact which specifies or guides an analysis 212 without itself containing procedural code
312 machine learning model; assumed to be trained unless indicated otherwise; computational
314 gapping generally, i.e., a characteristic of a cloud S that distinguishes S from all public clouds such that software running on public clouds does not deploy or run the same on S
316 gapping constraint, i.e., representation of gapping in a particular specialized cloud S; some examples include air-gap constraints 406, geolocation constraints 424, and government security constraints 434 318 false positive; digital
320 filter generally; computational
322 interface generally
402 non-permitted item; digital or computational
404 air-gap, i.e., separation of a network from the internet or from another network which prevents network transmission (wired or wireless) while the gap in in effect; the gap may be permanent, or may be almost permanent in that it is in effect at least 90% of the time
406 air-gap constraint, as represented in a network N, e.g., by a lack of physical network connections from network N to the internet; computational behavior or digital value or both
408 deny list; list of terminology which is discouraged or prohibited from appearing in source code, resources, or computational output of a specialized cloud; digital
410 deny list expression, e.g., literal string, regular expression, or Boolean combination of these which defines a particular set of one or more elements in a deny list; digital
412 fragile code; may be source code 130 or other code or a resource; digital
414 morph code; may be source code 130 or other code or a resource; digital
416 security review; procedure which involves gathering information about a potential or actual security risk, evaluating a security risk, formulating steps to manage security risk, or similar security management activity
418 security review flag; digital value indicating in some cases that a security review is suggested, or in some cases is required
420 need-to-know authorization as represented in a system 202; digital
422 geolocation, as represented in a system 202; may be coordinates, or correspond to legal or regulatory borders, e.g., a nation or a regulatory jurisdiction area; digital
424 geolocation constraint, e.g., on the physical location of cloud servers, cloud processing, cloud storage, etc., as represented in a system 202; computational behavior or digital value or both
426 software developer; an example of a user 104
428 software developer security clearance, as represented in a system 202; computational behavior or digital value or both
430 required item; digital or computational
432 government or corporate or institutional security
434 security 432 constraint, as represented in a system 202; computational behavior or digital value or both
500 flowchart; 500 also refers to cloud software compatibility assessment methods that are illustrated by or consistent with the FIG. 5 flowchart
502 computationally obtain access to cloud software, e.g., via repository 134 communications, build tool 122 API communications, or other computational activity
504 computationally analyze software 210 for compatibility with a particular specialized cloud 306, or a gapping constraint 316, or both; may include running one or more analyses 212 in a system 202
506 computationally report a digital result of analyzing 504, e.g., by configuring a display 126, writing to a file, sending an email or text, etc.
508 computationally identify a non-permitted item in software 210
510 presence of a non-permitted item in software 210, as represented in a system 202; computational behavior or digital value or both
512 computationally ascertain a required item in software 210
514 lack of a required item in software 210, as represented in a system 202; computational behavior or digital value or both
516 computationally find a fragile code in software 210
518 computationally detect a morph code in software 210
520 computationally locate a match to a deny list expression in software 210
522 computationally flag a software 210 for security review, e.g., by setting a flag 418, sending an email or text, etc., or adding an identifier of the software to a digital review list
524 computationally filter out a false positive 318, e.g., so it is not reported 506 or so it is reported only in response to a query asking specifically for false positives
526 computationally receive a need-to-know authorization, e.g., via an API
528 computationally disclose a deny list expression, e.g., by configuring a display 126 to show the expression, sending an email or text, etc. containing the expression, or writing the expression to a file
530 computationally determine a need-to-know authorization has not been received 526, e.g., by checking a status variable
532 computationally refuse to disclose a deny list expression, e.g., by displaying a refusal message or by ignoring a received disclosure request
534 computationally check for a characteristic without necessarily succeeding, e.g., try to identify 508, try to ascertain 512, try to find 516, try to detect 518, try to locate 520
536 characteristic, e.g., an item 402, 430, a code 412, 414, or an expression 410; digital
538 any step discussed in the present disclosure that has not been assigned some other reference numeral; 538 may thus be shown expressly as a reference numeral for various steps, and may be added as a reference numeral for various steps without thereby adding new matter to the present disclosure

### CONCLUSION

In short, the teachings herein provide a variety of cloud software compatibility assessment functionalities 206 which operate in enhanced systems 202. To decrease development revision cycle time and reduce deployment and execution errors when porting software 210 from a public cloud 214 to a specialized cloud 306, the software is analyzed 504 for certain characteristics 536. Analysis 504 may check for non-permitted items 402, required items 430, fragile code 412, morph code 414, or deny list expressions 410, for example. The particular items, codes, expressions, or other characteristics 536 targeted by analysis derive from gapping constraints 316 that distinguish the specialized cloud 306 from public clouds 214, such as an air-gap constraint 406, a geolocation constraint 424, or a government security constraint 434. Software cloud compatibility 204 analyses may be added, removed, or updated using a modular 308 framework architecture, using declarative analysis module declarations 310, or both. False positive 318 analysis results may be filtered out 524. Analysis results 304 may include suggestions. Cloud compatibility analysis 504 helps a public cloud developer 426 make improvements proactively instead of waiting for compatibility feedback from a specialized cloud developer 426.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; innovators are not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured with cloud software compatibility assessment functionality, the computing system comprising:
a processor; and
a memory storing instructions that, when executed by the processor, cause the computing system to:
access source code of cloud software;
analyze the source code for compatibility with a specialized cloud, wherein the analyzing comprises:
identifying a deny list expression in the source code, the deny list expression being associated with the specialized cloud;
flagging the source code for a security review in response to identifying the deny list expression; and
reporting a result of the analyzing, including an indication that the source code includes the deny list expression.

2. The computing system of claim 1 further comprising:
a machine learning model, wherein the machine learning model is trained to identify the deny list expression in the source code using labeled training data.

3. The computing system of claim 1 wherein the specialized cloud is subject to one or more of the following gapping constraints:
a geolocation constraint;
an air-gap constraint; and
a governmental security constraint.

4. The computing system of claim 1 comprising a false identification of a deny list expression in the source code, wherein the processor is further configured to:
filter out the false identification prior to reporting the result.

5. The computing system of claim 1 wherein the result includes the deny list expression organized into a category.

6. The computing system of claim 1 further comprising:
a Multi-Cloud Unification (MCU) framework.

7. The computing system of claim 6, wherein the processor is further configured to:
utilize the MCU framework to analyze the source code.

8. A method of operating a computing system to assess cloud software compatibility, the method comprising:
accessing, by the computing system, source code of cloud software
analyzing, by the computing system, the source code for compatibility with a specialized cloud, wherein the analyzing comprises:
identifying a deny list expression in the source code, the deny list expression being associated with the specialized cloud;
flagging the source code for a security review in response to identifying the deny list expression; and
reporting, by the computing system, a result of the analyzing, including an indication that the source code includes the deny list expression.

9. The method of claim 1 further comprising:
utilizing a machine learning model, wherein the machine learning model is trained to identify the deny list expression in the source code using labeled training data.

10. The method of claim 1 wherein the specialized cloud is subject to one or more of the following gapping constraints:
a geolocation constraint;
an air-gap constraint; and
a governmental security constraint.

11. The method of claim 1, wherein the source code includes a false identification of a deny list expression, the method further comprising:
filtering out the false identification prior to reporting the result.

12. The method of claim 1 wherein the result includes the deny list expression organized into a category.

13. The method of claim 1 further comprising:
implementing a Multi-Cloud Unification (MCU) framework.

14. The method of claim 13 further comprising:
analyzing the source code by implementing the MCU framework.

15. A non-transitory computer-readable medium stored thereon instructions to assess cloud software compatibility that, in response to execution, cause a system comprising a processor to perform operations, the operations comprising:
accessing source code of cloud software
analyzing the source code for compatibility with a specialized cloud, wherein the analyzing comprises:
identifying a deny list expression in the source code, the deny list expression being associated with the specialized cloud;
flagging the source code for a security review in response to identifying the deny list expression; and
reporting a result of the analyzing, including an indication that the source code includes the deny list expression.

16. The non-transitory computer-readable medium of claim 15 further comprising:
utilizing a machine learning model, wherein the machine learning model is trained to identify the deny list expression in the source code using labeled training data.

17. The non-transitory computer-readable medium of claim 15 wherein the specialized cloud is subject to one or more of the following gapping constraints:
a geolocation constraint;
an air-gap constraint; and
a governmental security constraint.

18. The non-transitory computer-readable medium of claim 15, wherein the source code includes a false identification of a deny list expression, the operations further comprising:
filtering out the false identification prior to reporting the result.

19. The non-transitory computer-readable medium of claim 15 wherein the result includes the deny list expression organized into a category.

20. The non-transitory computer-readable medium of claim 15 further comprising:
implementing a Multi-Cloud Unification (MCU) framework; and
analyzing the source code using the MCU framework.
